(19) United States
(12) Patent Application Publication
(10) Pub. No.: US 2002/0030451 A1
(43) Pub. Date: Mar. 14, 2002

(54) Ballast circuit having voltage clamping circuit

(76) Inventor: Mihail S. Moisin, Brookline, MA (US)

Correspondence Address: NUTTER MCCLENNEN & FISH LLP, ONE INTERNATIONAL PLACE, BOSTON, MA, 02110, US

(21) Appl. No.: 09/789,921

(22) Filed: Feb. 21, 2001

Related U.S. Application Data
(60) Provisional application No. 60/184,894, filed on Feb. 25, 2000.

(51) Int. Cl. H05B 37/02

(52) U.S. Cl. 315/219; 315/224

(57) ABSTRACT

The present invention provides a ballast circuit for energizing a load, such as a fluorescent lamp. The ballast circuit can include an inverter circuit that receives a DC voltage across a positive voltage rail and a negative voltage rail, and produces an AC voltage for driving the load. The ballast circuit can further include two inductors coupled in series to one another, and coupled between the inverter and the load to provide a current path between the inverter and the load. A voltage clamping circuit clamps the voltage at the coupling junction between the two inductive elements to a pre-determined positive value during one half cycle of the inverter AC voltage, and to a pre-determined negative value during the other half cycle of the inverter AC voltage.

### RELATED APPLICATION

This application claims priority to a provisional application filed on Feb. 25, 2000 and having a Ser. No. 60/184,894. This provisional application is incorporated herein by reference.

### BACKGROUND OF THE INVENTION

The present invention relates generally to electronic ballast circuits for energizing a load, and more particularly to electronic ballast circuits having clamping circuits.

A variety of ballast circuits for energizing devices, such as fluorescent lamps, are known. An electronic ballast circuit receives a relatively low frequency input AC (Alternating Current) voltage and provides a relatively high frequency AC output voltage for driving a load. Typically, the low frequency input AC voltage corresponds to the standard 110 V, 60 Hz line voltage, and the output voltage has a relatively high frequency in the range of tens of kHz.

During operation of a ballast circuit, transient voltages can appear which can disrupt the operation of the ballast, and in some cases damage various components of the circuit. Such transient voltage can be riding, for example, on the input line voltage. For example, transient voltages can disrupt proper operation of the switching elements of a ballast circuit, e.g., resulting in cross conduction of the switching elements. Further, when the ballast is utilized for energizing a fluorescent lamp, high voltages are needed to strike the lamp if the filaments are cold, e.g., room temperature.

Thus, it is desirable to provide electronic ballasts that include circuitry for providing protection against transient signals.

It is also desirable to provide electronic ballasts that can heat the filaments of the lamp before the lamp striking.

### SUMMARY OF THE INVENTION

The present invention provides a ballast circuit for energizing a load, such as a fluorescent lamp. In one aspect, a ballast circuit of the invention includes an inverter circuit which receives a DC voltage across a positive voltage rail and a negative voltage rail and produces an AC voltage for energizing the load. The ballast circuit can further include a resonant inductive element coupled between the inverter and the load to provide a current path therebetween. A voltage clamping circuit connected across the positive and negative voltage rails and also coupled to the inductive element clamps the voltage at one end of the inductive element, i.e., the end coupled to the load. More particularly, the clamping circuit clamps the voltage to a pre-determined positive value during a first half cycle of the inverter AC voltage and to a pre-determined negative value during a second half cycle of the inverter AC voltage.

In a related aspect, the voltage clamping circuit can include a clamping diode coupled between the end of the inductive element coupled to the load and the positive voltage rail. The clamping circuit can further include another clamping diode coupled between the end of the inductive element coupled to the load and the negative voltage rail such that the anode terminal of one diode is connected to the cathode terminal of the other diode. In operation, each diode begins conducting when the voltage at the circuit point connecting the two diodes exceeds a pre-determined positive or negative voltage, thereby clamping the voltage at that point.

In another aspect, a ballast circuit according to the teachings of the invention includes an inverter circuit receiving DC voltage across a positive voltage rail and a negative voltage rail, and providing an AC voltage for energizing a load, e.g., a fluorescent lamp. The ballast circuit further includes two resonant inductive elements inductively coupled to each other at a coupling junction, and further coupled to the load so as to provide a current path from the inverter to the load. A dc blocking capacitor can be optionally coupled in series between the load and one of the resonant inductive elements. The ballast circuit further includes a voltage clamping circuit connected across the positive and the negative voltage rails clamps a voltage at the coupling junction between the two inductive elements to a pre-determined positive value during one half cycle of the inverter AC voltage, and to a predetermined negative value during another half cycle of the inverter AC voltage.

The clamping circuit can include, for example, two diodes connected end-to-end between the positive and negative voltage rails. One diode is connected between the coupling junction between the two inductive elements and the positive voltage rail, and the other diode is connected between the coupling junction and the negative voltage rail such that the cathode terminal of one diode is connected to the anode terminal of the other diode.

In a related aspect, the inverter circuit includes two switching elements, such as transistors, arranged, for example, in a half bridge configuration. Further, the ballast circuit includes two control circuits coupled to the switching elements such that each control circuit controls a conduction state of one switching element. Each control circuit can include an inductive element inductively coupled to the resonant inductive elements, and can also include a capacitive element and a resistive element coupled electrically in series with the inductive element.

In another aspect, the ballast circuit of the invention can include a transformer for energizing the load. The transformer can have a primary winding coupled in series to the resonant inductive element and a secondary winding coupled to the load. The inverter circuit applies an AC voltage to the primary winding which induces an AC voltage in the secondary winding for energizing the load.

Another aspect of the present invention provides a ballast circuit for energizing a load, such as a fluorescent lamp, which includes an inverter circuit that receives a DC voltage across a positive voltage rail and a negative voltage rail and provides an AC voltage for energizing the load. The circuit further includes a resonant inductive element coupled at one end to the inverter circuit and at another end to a primary winding of a transformer whose secondary winding is coupled to the load for energizing it. The circuit further includes a resonant capacitor connected in parallel to the primary winding. A positive temperature coefficient (PTC) element is coupled to the primary winding so as to limit current flow to the resonant capacitor during start-up, i.e., when the temperature of the PTC element and hence its impedance is low. This in turn limits the voltage across the primary winding, and thus clamps the voltage across the lamp below a strike voltage, i.e., a voltage needed to ignite the lamp.

The lamp can include two filaments, e.g., a cathode and an anode, and the transformer can another secondary winding coupled across one filament, e.g., the cathode. During start-up, the winding coupled to the filament provides heating of the cathode while the PTC element clamps the voltage across the lamp below a strike voltage, thereby preventing the lamp from igniting before sufficient heating of the cathode is achieved. Similarly, a third secondary coupled across the other filament, e.g., the anode, can provide heating of this filament during the start-up period. Alternatively, the transformer can have one secondary winding that forms a circuit loop with the two filaments of the lamp, to heat the filaments during the start-up and also provide a strike voltage across the lamp once sufficient heating is achieved.

According to another aspect, the invention provides a ballast circuit for energizing a lamp which includes an inverter circuit, a resonant inductive element coupled at one end to the inverter circuit, and at another end to a transformer having three primary windings, two of which are inductively coupled, and a secondary winding coupled across the lamp. A resonant capacitive element is coupled across one of the primary windings, and a PTC element forms a circuit loop with the two primary windings that are inductively coupled to one another. The PTC element limits current to the capacitive element during the start-up period to a value that is sufficiently low such that the voltage across the lamp is clamped below a strike voltage. One of the primary windings can be connected at one end to the resonant inductive element and at another end to a circuit junction that forms a connection point between two diodes coupled end-to-end between a positive voltage rail and a negative voltage rail of the circuit.

In one embodiment, the inductive coupling between two of the primary windings is configured such that, during the normal operation of the lamp, the magnetic flux through one winding substantially cancels the flux through the other winding to substantially eliminate current flow through the PTC element.

In a related aspect, the invention provides a ballast circuit for energizing a fluorescent lamp having an inverter circuit that receives a DC voltage across a positive voltage rail and a negative voltage rail and produces an AC voltage for energizing the lamp. The circuit further includes two inductive elements coupled in series at a first circuit junction, and coupled to the inverter circuit to provide a current path from the inverter circuit to a transformer. More particularly, one end of one of the inductive elements is connected to the inverter and one end of the other inductive element is connected to one winding of the transformer. The transformer has three windings, one of which is connected across one filament of the lamp, and another connected across the other filament. Further, two of the windings are coupled in series with each other. A resonant capacitive element is coupled between the connection point of the inductive elements and the transformer and one of the voltage rails.

The circuit also includes two diode coupled end-to-end between the positive voltage rail and the negative voltage rail, and a PTC element coupled between a connection point of the inductive elements and the connection points of the diodes. Alternatively, the PTC element can be connected between the connection point of the inductive element and one of the voltage rails. During the start-up period, the PTC element limits current flow through the resonant capacitor by providing an alternative low impedance current path. This in turn limits the voltage applied to the lamp below a strike voltage so as to allow heating of the lamp filaments while preventing the lamp from striking.

Illustrative embodiments of the invention are described below with reference to the following drawings.

### BRIEF DESCRIPTION OF THE DRAWINGS

FIG. 1 is an exemplary ballast circuit having a voltage clamping circuit according to the teachings of the invention;

FIG. 2 illustrates exemplary control circuits for controlling the conduction states of the switching elements of the inverter circuit of FIG. 1;

FIG. 3 illustrates a ballast circuit having a transformer for energizing a lamp, and further having a voltage clamping circuit in accord with the teachings of the invention;

FIG. 4A illustrates a ballast circuit for energizing a lamp according to the teachings of the invention which provides heating the lamp cathode prior to the lamp striking;

FIG. 4B illustrates a ballast circuit according to the teachings of the invention for energizing a lamp which provides current heating of the lamp cathode before the lamp striking;

FIG. 5 schematically depicts the strike sequence of a lamp energized by a ballast according to the teachings of the invention;

FIG. 6 illustrates a ballast circuit according to the invention having a multi-level clamping circuit;

FIG. 6A shows an exemplary detailed circuit diagram of a ballast in accord with the embodiment of FIG. 6;

FIG. 7 illustrates a ballast circuit for energizing a lamp according to the invention having a positive temperature coefficient (PTC) element for clamping the voltage across the lamp to a pre-strike value during the start-up period; and

FIG. 7A depicts an exemplary detailed circuit implementation of the ballast circuit of FIG. 7.

### DETAILED DESCRIPTION

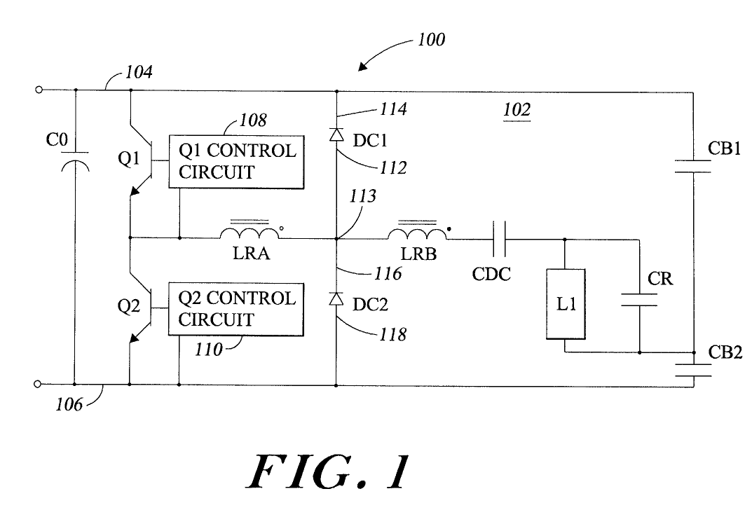

FIG. 1 shows an exemplary ballast circuit 100 having a voltage clamping circuit in accordance with the present invention. The ballast circuit includes an inverter 102 for receiving a DC input signal from a rectifier (not shown), for example, on positive and negative voltage rails 104,106 and providing a relatively high frequency AC signal to a lamp L1. The inverter 102 includes first and second switching elements Q1,Q2, which are shown as transistors, coupled in a so-called half bridge configuration. It is understood that the invention is applicable to other resonant circuit arrangements, such as full bridge inverters. A first control circuit 108 controls the conduction state of the first switching element Q1 and a second control circuit 110 controls the conduction state of the second switching element Q2. Switching element control circuits are well known to one of ordinary skill in the art.

A first resonant inductive element LRA has one end coupled to a point between the first and second switching elements Q1,Q2 and another end coupled to a second resonant inductive element LRB. In one embodiment, the first and second resonant inductive elements LRA,LRB, are inductively coupled to one another with respective polarities indicated with conventional dot notation. An optional DC-blocking capacitor CDC can be connected in series with the second resonant inductive element LRB. The lamp L1 can be coupled between the resonant inductive element LRB and a point between first and second capacitors CB1,CB2 connected across the positive and negative voltage rails 104,106. A resonant capacitor CR is coupled in parallel with the lamp L1.

A first clamping diode DC1 includes an anode 112 coupled to a point 113 between the first and second resonating elements LRA,LRB and a cathode 114 coupled to the positive voltage rail 104 of the inverter. A second clamping diode DC2 includes a cathode 116 connected to the point 113 between the first and second resonating elements LRA,LRB and an anode 118 coupled to the negative voltage rail 106.

The first and second control circuits 108,110 alternatively bias the first and second switching elements Q1,Q2 to a conductive state for achieving resonant operation of the circuit. More particularly, the first switching element Q1 is conductive while the AC signal to the lamp L1 is positive and the second switching element Q2 is conductive while the AC signal to the lamp L1 is negative. The impedances of the various circuit elements, such as the resonant inductive and capacitive circuit elements LRA,LRB,CR, as well as the lamp L1, determine the frequency at which the circuit resonates. It is understood that the duty cycle for the switching elements is less than fifty percent to avoid cross-conduction. Cross-conduction refers to the condition where both switching elements are conductive simultaneously so as to create a short between the voltage rails 104,106, which can damage the circuit components.

FIG. 1A illustrates another embodiment of a ballast circuit according to the invention that includes only one inductive resonant element LRA. The diodes DC1 and DC2 clamp the voltage at the circuit junction 113a, as described in more detail below.

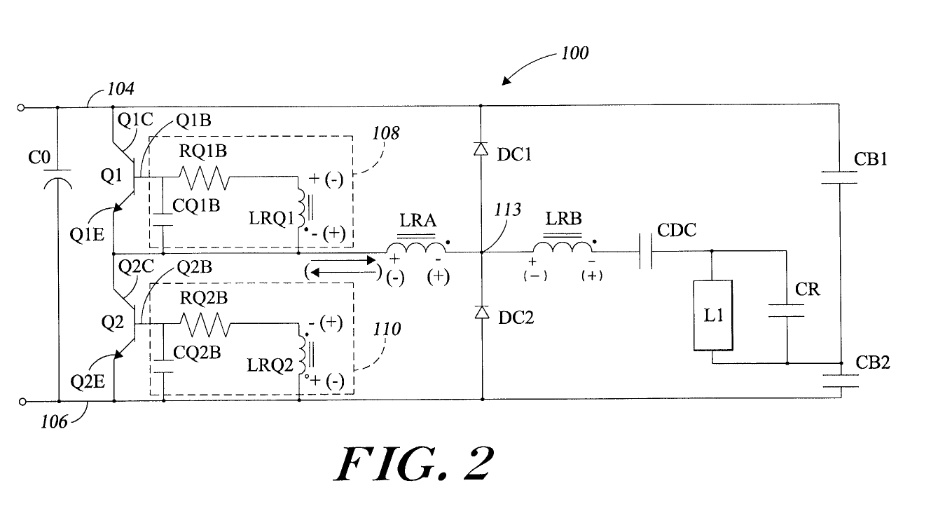

FIG. 2 shows exemplary embodiments of the first and second control circuits 108,110 of FIG. 1 for controlling the conduction state of the respective first and second switching elements Q1,Q2. The first control circuit 108 includes a first capacitor CQ1B coupled between the base and emitter terminals Q1B,Q1E of the first switching element Q1. A first resistor RQ1B and a first inductive bias element LRQ1 are coupled so as to form a series circuit path from the base terminal Q1B to the emitter terminal Q1E. The first inductive bias element LRQ1 is inductively coupled to the resonant inductive elements LRA,LRB with a polarity indicated with conventional dot notation.

The second control circuit 110 includes a second capacitor CQ2B, a second resistor RQ2B, and a second inductive bias element LQ2B coupled in a manner similar to that described above for the first control circuit 108. The second inductive bias element LQ2B is inductively coupled to the resonant inductive elements LRA,LRB.

In general, when the first switching element Q1 is conductive current flows in a first direction from the first resonant inductive element LRA to the second resonant inductive element LRB. Looking at the respective polarities, a positive voltage appears at the unmarked ends, i.e., no dot, of each of the inductively coupled elements LRA,LRB,LRQ1,LRQ2. The first inductive bias element LRQ1 positively biases the first switching element Q1 to a conductive state. The respective positive “+” and negative “−” voltages on the inductive elements are shown without parentheses when Q1 is conductive and with parentheses when Q2 is conductive.

Similarly, the second inductive bias element LRQ2 biases the second switching element Q2 to the conductive state when the current switches directions and flows from the second resonant inductive element LRB to the first resonant inductive element LRA. That is, when a positive voltage appears at the marked end of the inductive elements LRQ1 and LRQ2, the switching element Q2 is biased into a conductive state. Thus, the first and second inductive bias elements LRQ1,LRQ2 provide a voltage to the respective first and second switching elements Q1,Q2 that is proportional to the voltages at the resonant inductive elements LRA,LRB.

In operation, the first and second clamping diodes DC1,DC2, in combination with the first and second resonant elements LRA,LRB, minimize the likelihood of cross conduction due to transient signals. In addition, this arrangement tends to maintain the frequency of the load current so as to optimize operating conditions for the switching transistors and other circuit elements. It will be appreciated that conditions altering the predicted switching times of the transistors, e.g., frequency shifts, can degrade their performance. For example, an upward frequency shift can lead to transistor storage times not being met, thereby decreasing their useful life. The clamping diodes add artificial reactive load that advantageously directs current to the storage capacitor and stabilizes the circuit operating frequency.

In the case where a transient signal generates a relatively high voltage signal on the inductively coupled resonant inductive elements LRA,LRB, one of the clamping diodes DC1 ,DC2 can be biased to a conductive state to clamp the voltage at the connecting junction of the two inductors LRA and LRB. More particularly, a predetermined voltage at point 113, which corresponds to the difference of the voltages generated by the first and second resonant inductive elements LRA,LRB will bias a clamping diode DC1,DC2 to the conductive state. That is, when a transient signal occurs that would generate an instantaneous voltage in at least one of the resonant inductive elements LRA,LRB greater than a voltage rail 104,106, a clamp diode DC1,DC2 may become biased to the conductive state and thereby clamp the voltage.

For example, when the first switching element Q1 is conductive, load current flows from the first resonant inductive element LRA to the second inductive element LRB and on to the lamp L1. During normal operating conditions, the clamping diodes DC1 ,DC2 will not become biased to their conductive states in absence of transient signals. When a transient signal occurs, the voltages at the first and second resonant inductive elements LRA,LRB will concomitantly increase. Where the first resonant inductive element LRA has a greater number of turns, e.g., 150 turns, than the second resonant inductive element LRB, e.g., 20, the voltage at the first resonant inductive element dominates. Looking at the respective polarities of the resonant inductive elements LRA,LRB, when the current flowing through the inductive elements increases to a predetermined level, the voltage at the point 113 between the first and second resonant inductive elements LRA,LRB will bias the second clamping diode DC2 to a conductive state. Similarly, when the second switching element Q2 is conductive, the first clamping diode DC1 becomes conductive when the voltage difference between the first and second resonant inductive elements LRA,LRB increases to a predetermined level.

It is understood that the total impedance of the first and second resonant inductive element LRA,LRB, as well as the turns ratio, can be selected to achieve a desired clamp voltage.

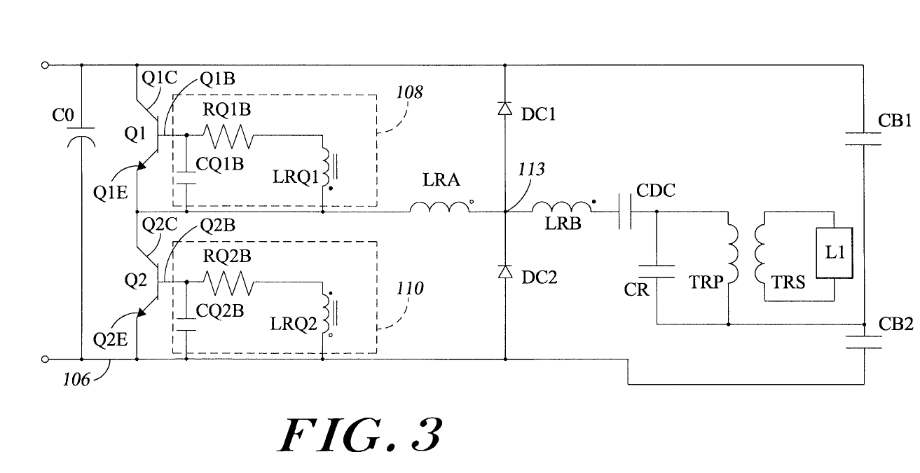

As shown in FIG. 3, the clamping circuit described above is applicable to ballast circuits that utilize a transformer to energize a lamp. In this embodiment, the primary winding of a transformer resonates with resonant inductive elements LRA,LRB and resonant capacitor CR to provide a voltage on the secondary winding of the transformer for energizing the lamp L1.

It is understood that the various circuit components can have impedances and other characteristics selected from a wide range of values. In one exemplary embodiment, such as the one shown in FIG. 2., illustrative values for circuit components are set forth in Table 1 below.

TABLE 1

| Component | Value | |
|---|---|---|
| LRA, LRB total impedance | 3 | mH |
| LRA | 150 | Turns |
| LRB | 20 | Turns |
| RQ1B, RQ2B | 50 | ohms |
| CQ1B, CQ2B, CDC | 0.1 | microF |
| CR | 0.0033 | microF |
| LRQ1, LRQ2 | 2 | Turns |

The voltage clamping circuit described above protects circuit elements, such as half-bridge inverter transistors, from transient signals that can generate relatively significant voltages in a resonating inductive element. Such transient signals can be due to lamp removal, load current variations, and the like. The resonant inductive elements in combination with the clamping diodes clamp transient voltages generated by resonant inductive elements to a predetermined level thereby minimizing the likelihood of cross-conduction and circuit damage.

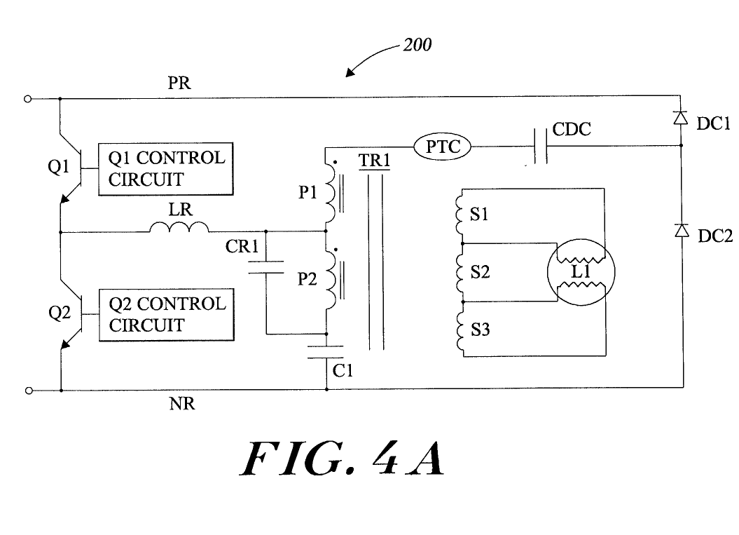

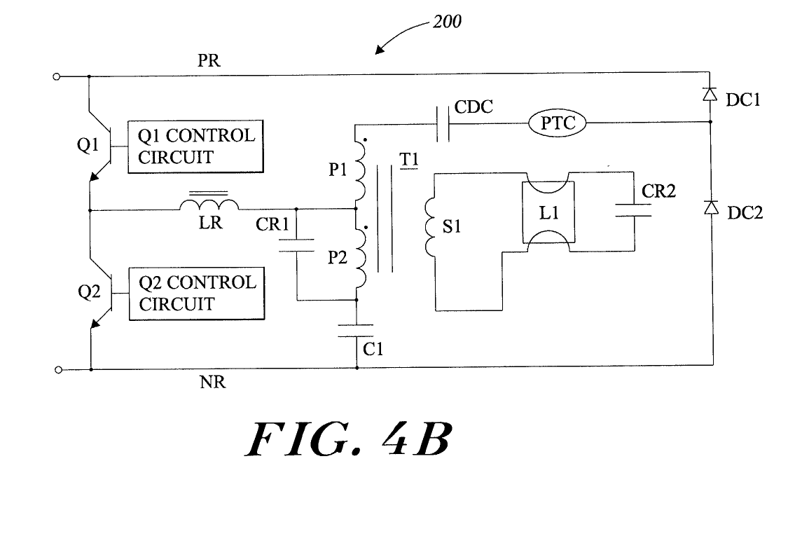

FIG. 4A shows a ballast 200 according to the invention that warms the lamp cathodes, which is commonly referred to as rapid start, prior to the lamp striking. The ballast applies a voltage to the lamp that increases until the lamp strikes or the voltage reaches a predetermined limit. The ballast 200 includes an inverter 200a having first and second switching elements Q1,Q2, which are shown as transistors, coupled in a half-bridge configuration between positive and negative voltage rails PR,NR. It is understood, however, that the invention is applicable to other resonant circuit configurations, such as full bridge arrangements. The ballast 200 further includes a resonating inductor LR having one end connected to a point between the first and second switching elements Q1,Q2 and the other end coupled to a first resonating capacitor CR1. The resonating capacitor CR1 can be coupled to the negative rail NR via a capacitor C1.

The lamp L1 can be energized by means of a transformer TR1 having a series of windings. In an exemplary embodiment, the transformer TR1 includes first and second primary windings P1,P2 and first, second and third secondary windings S1,S2,S3. First and second clamping diodes DC1,DC2 are coupled end-to-end from the positive to the negative voltage rails PR,NR of the inverter. The second primary winding P2 is coupled in parallel with the first resonant capacitor CR1. A series circuit path extending from a point between the diodes DC1,DC2 to the negative voltage rail NR includes a DC-blocking transistor CDC, a positive temperature coefficient element (PTC), the first and second primary windings P1,P2, and the first capacitor C1.

PTCs are well known to one of ordinary skill in the art. In general, PTCs have first and second impedance modes. More particularly, a PTC, when cool, has a relatively low resistance or impedance. When the PTC temperature increases to a predetermined value, the impedance increases dramatically until reaching a relatively high impedance level. While it is understood that the impedance values can vary widely, the present invention contemplates a PTC having a low impedance in the order of tens of ohms, e.g., 50 ohms, and a high impedance in the order of thousands of ohms.

The first secondary winding S1 is coupled across a first filament FL1 of the first lamp L1 and the third secondary winding S3 is coupled across a second filament FL2 of the lamp. The second secondary winding S2 of the transformer is coupled to the first and second filaments. This arrangement can be referred to as cathode voltage heating.

In an alternative embodiment shown in FIG. 4B, the cathode can be heated by current heating. A secondary winding S1′ is coupled to one end of the lamp filaments FL1 ,FL2 and a second resonant capacitor CR2 is coupled to the other end of the filaments. Prior to lamp ignition, current flowing through the lamp filaments warms them via resistive heating.

In an exemplary embodiment, the first primary winding is in the order of 20 turns, the secondary winding is in the order of about 100 turns, the main secondary winding is in the order of 200 turns, and the voltage heating secondary windings are in the order of 2 turns.

In operation, the circuit begins to resonate and to generate current flow through the circuit. Initially, the PTC provides a low impedance current path that clamps the voltage across the lamp and the current through the cathode to relatively low levels. More particularly, the PTC in combination with the diodes D1,D2 clamps the voltage to a predetermined level so as to limit the current through the resonant capacitor CR and the proportional voltage across the transformer. During this time, the cathode is subjected to voltage (FIG. 4A) or current heating (FIG. 4B).

When the temperature of the PTC reaches a predetermined level, the resistance of the PTC increases dramatically, such as in the kilo Ohm range. When the PTC switches to a high impedance mode, current through the resonant capacitor CR increases as the PTC now provides a high impedance signal path. The increased voltage across the resonant capacitor CR concomitantly increases the voltage across the lamp to a level sufficient to strike the lamp. The voltage across the cathode also increases significantly. After current begins to flow through the lamp, current and voltage levels settle to operational levels.

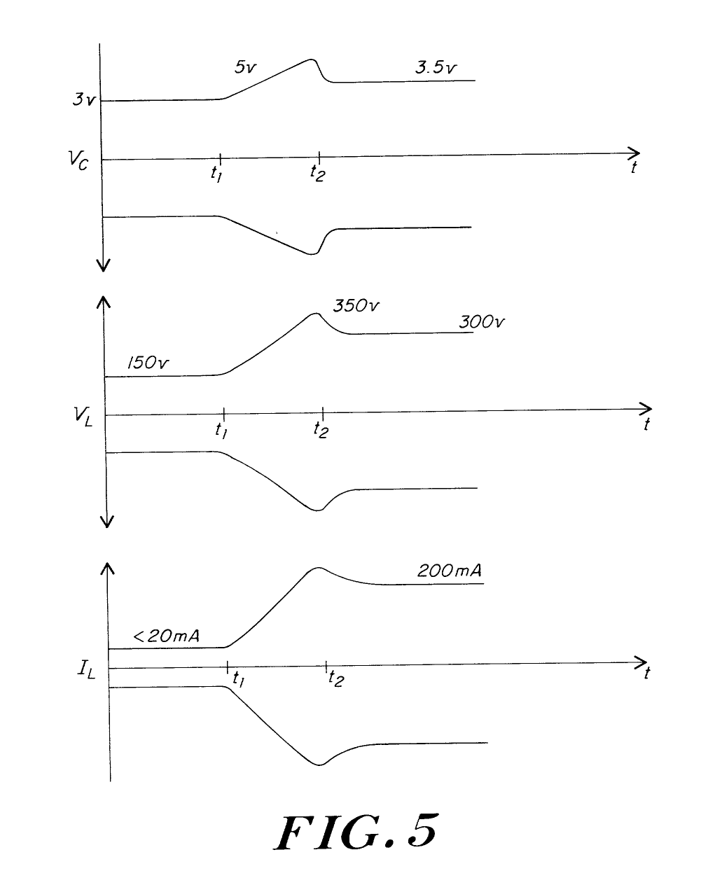

FIG. 5 graphically shows the above lamp strike sequence. It is understood that voltage levels indicate root means square (RMS) values. It is further understood that the plot is not drawn to scale in amplitude or time but rather is intended to facilitate an understanding of circuit operation. When the PTC is cool, the cathode voltage Vc will be about 3 Volts. The PTC temperature increases until at time t1, it switches to a high impedance mode. In response to the increase in the PTC impedance, and the corresponding rise in current through the resonant capacitor CR, the cathode voltage Vc rises to about 5 V. Similarly, the lamp voltage V1 increases from about 150 V, which is not sufficient to strike the lamp, to about 350 V, for example, which should strike the lamp. The lamp current I1 also increases from less than 20 mA prior to time t1 to more than 200 mA at time t2. At time t2, the lamp strikes and current flow through the lamp is initiated. After time t2, the cathode voltage settles to about 3.5V, the lamp voltage to about 300 V, and the lamp current to about 200 mA.

It should be understood that the above voltage and current values are provided to facilitate an understanding of the invention, and are not intended to limit the scope of the invention. Accordingly, these values can be varied without departing from the invention.

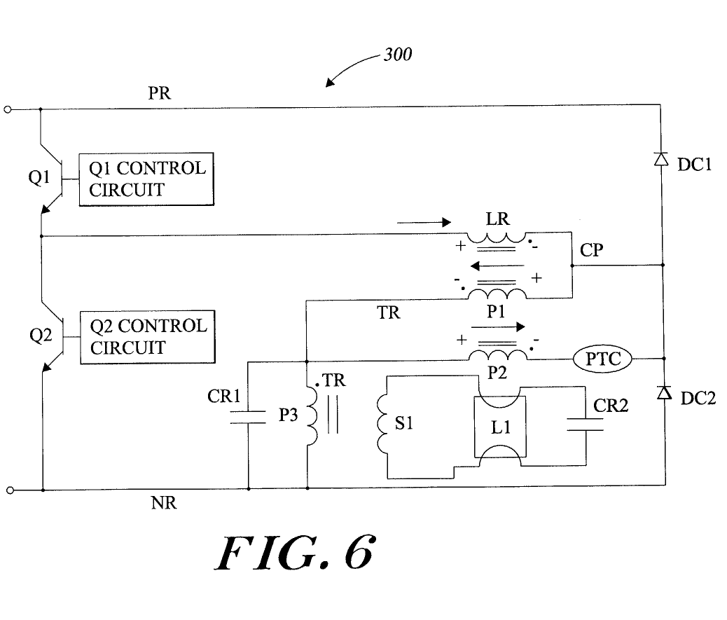

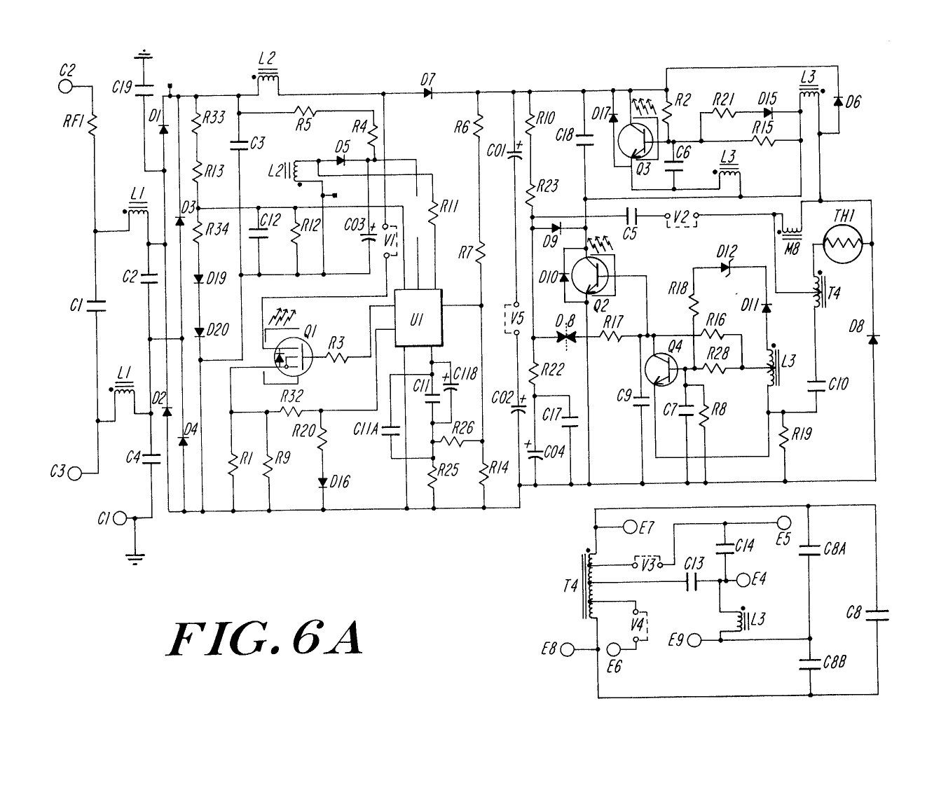

FIG. 6 shows another embodiment of a ballast 300 having an inverter 300a providing multi-level clamping and eliminating current flow through the PTC after striking of the lamp. The circuit includes a resonant inductive element LR and first, second, and third primary windings P1,P2,P3 of a transformer TR. First and second clamping diodes DC1 ,DC2 are coupled end to end across positive and negative voltage rails PR,VR of the inverter. A point CP between the first and second clamping diodes DC1,DC2 is connected to a point between the resonant inductive element LR and the first primary winding P1. That is, the cathode of DC2 and the anode of DC1 are coupled to a point between LR and P1. The second primary winding P2 is connected in series with a PTC element. One end of the PTC is coupled to the point CP between the first and second clamping diodes DC1,DC2, such that the first and second primary windings P1,P2 and the PTC form a circuit loop.

The third primary winding P3 has one terminal coupled to the first and second primary windings P1 ,P2 and the other terminal coupled to the negative voltage rail NR of the inverter. A secondary winding S1 of the transformer applies a voltage to the lamp L1. A resonant capacitor CR1 is coupled in parallel with the third primary winding P3.

In operation, the PTC is initially in a low impedance mode, and hence limits the signal levels applied to the lamp. More particularly, the PTC provides a low impedance path that limits the current flowing to the resonant capacitor CR1. That is, the PTC clamps the voltage across the lamp to a pre-strike level, e.g., a so-called low glow level of about 200 V.

When the PTC heats up and switches to a high impedance mode, the current through the resonant capacitor CR increases dramatically such that the lamp voltage applied by the third primary winding P3 increases until the lamp strikes. The connection of the point CP between the resonant inductive element LR and the first primary winding PI clamps the voltage to a second level, such as 350 V or 500 V, in a manner similar to that described above in connection with FIGS. 1-3. It is understood that applying 500 V to the lamp is generally associated with so called instant start ballasts. Even when a lamp cathode is broken, 500 volts applied to the lamp should initiate current flow through the lamp. In addition, 500 volts may strike a marginally operational lamp such as a lamp approaching so called end-of-life.

After striking, operational voltage and current levels are applied to the lamp. It is understood that the operational lamp voltage, e.g., 140 V, is lower than the PTC clamping voltage, e.g., 200 V. Thus, during the steady state operation, there is no current flow through the PTC. It will be appreciated that after ignition of the lamp, current through the PTC is not needed and decreases efficiency. In one embodiment, the respective polarities of the first and second primary windings P1,P2, which are indicated with conventional dot notation, may cancel flux. In the case where the flux cancels, there is no voltage source in the circuit loop formed by the first and second windings P1,P2 and the PTC, and therefore no current flow through the PTC.

FIG. 6A shows an exemplary detailed circuit diagram of a ballast in accordance with the embodiment of FIG. 6. The circuit diagram provides exemplary component values. Accordingly, it will be readily apparent to one of ordinary skill in the art, that these values can be varied without departing from the present invention. It is understood that the circuit of FIG. 6A shows an illustrative circuit for receiving an AC input signal and providing DC signal levels to the inverter.

While the concepts described herein are shown and discussed in conjunction with ballasts for energizing fluorescent lamps, it is understood that the invention is applicable to voltage regulators, motor control circuits and other such circuits utilizing inverter circuits.

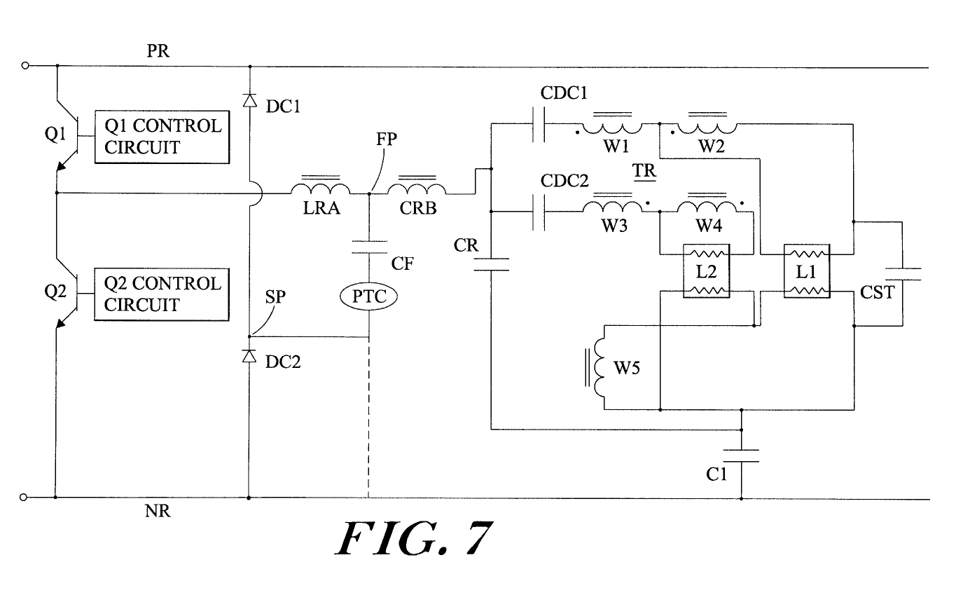

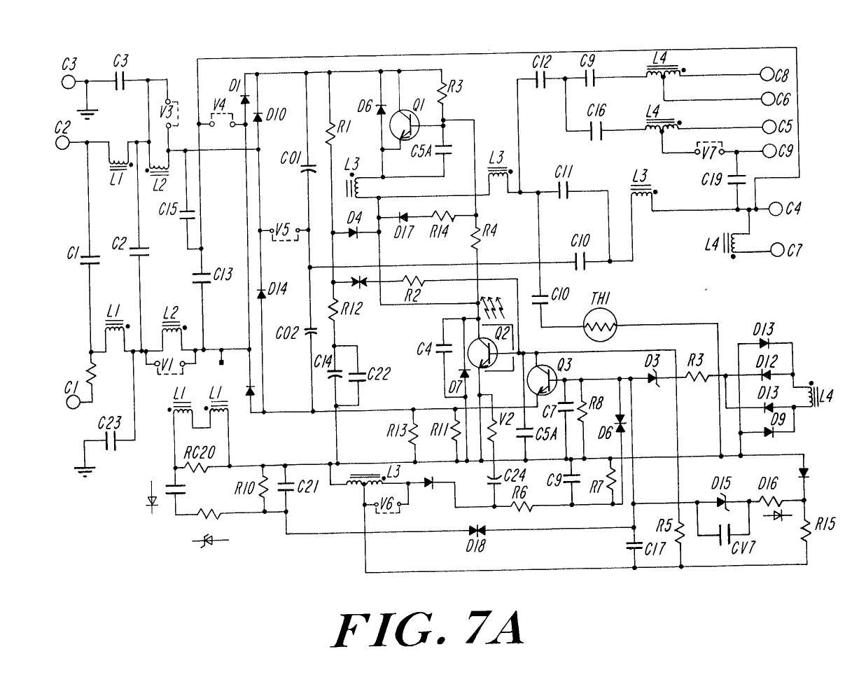

FIG. 7 shows another embodiment of a ballast 400 in accordance with the present invention. The ballast includes first and second switching elements Q1,Q2 coupled in a half bridge configuration with respective first and second control circuits for controlling the conduction states of the first and second switching elements. It is understood that the invention is applicable to other circuit configurations, such as full bridge circuits. First and second clamping diodes DC1,DC2 are coupled end-to-end across positive and negative rails (PR,NR) of the inverter. First and second resonant inductive elements LRA,LRB, which can be inductively coupled, are coupled end-to-end at a first point FP. A first capacitor CF and a PTC element are coupled so as to form a series circuit path between the first point FP and a second point SP between the first and second diodes DC1,DC2. Alternatively, the PTC can be coupled directly to the negative rail NR of the inverter as shown by dotted line, which alters the clamping threshold. A resonant capacitor CR has one end coupled to the second resonant inductive element LRB and the other end coupled to the negative rail NR via a first capacitor C1.

The circuit further includes a transformer TR having a series of windings that are effective to energize first and second lamps L1,L2. In an exemplary embodiment, a first transformer winding W1 has a first terminal coupled to LRB and to CR and a second terminal coupled to a first terminal of a second transformer winding W2. An optional DC blocking capacitor CDC1 can be coupled in series with the transformer winding W1. A circuit loop includes the second transformer winding W2 and a cathode of the first lamp L1 for voltage heating of the lamp cathode.

A similar circuit is formed from a second DC blocking capacitor CDC2, third and fourth transformer windings W3,W4. The second lamp cathode and the fourth transformer winding W4 form a circuit loop for heating the second lamp cathode.

The circuit further includes a fifth transformer winding W5 coupled across the anodes of the first and second lamps L1 ,L2 such that a first circuit loop includes the first lamp anode and W5 and a second circuit loop includes the second lamp anode and W5. The fifth winding W5 can have one terminal coupled to the common anode terminal and the other terminal coupled to the first capacitor C1. An optional start delay capacitor CST can be coupled across a cathode and an anode of one of the lamps.

In operation, the inverter begins to resonate and to energize the transformer TR. Initially, the PTC limits the current flowing through the resonant capacitor CR, which concomitantly limits signal levels applied to the lamps. The voltages applied to the lamp cathodes, as well as the lamp glow current, are limited by the PTC in combination with the clamping diodes DC1,DC2. As described above, when the PTC reaches a predetermined temperature, its impedance increases sharply to a high impedance mode that causes the voltage across the resonant capacitor CR to increase rapidly. The cathode voltages at the lamps as well as the lamp current proportionally increase until the lamp strikes. After striking, the circuit applies operational voltage and current levels to the lamps.

Looking to the polarities of the transformer windings, which are indicated with conventional dot notation, it can be seen that the flux generated by the respective windings cancels each other during steady state operation. Thus, the voltages applied to the cathodes after the lamp strikes are minimized, thereby increasing the efficiency of the ballast and extending its useful life.

It is understood that the start delay capacitor CST facilitates striking of the second lamp L2 prior to the first lamp L1. The start delay capacitor CST is not required since there will always be some degree of asymmetry between two lamps connected in the circuit. As current flows through the start delay capacitor CST, voltages on the transformer windings W1,W2,W3,W4 appear due to this current flow. Flux on the windings will not cancel since the current is asymmetrical. During cathode warming (PTC in low impedance mode), the voltages on windings W2,W4 provide voltage heating of the respective lamp cathodes. After the PTC switches, the current flowing through the delay start capacitor CST increases and the voltages appearing on the windings also increase until the second lamp strikes. It is understood that the asymmetrical nature of the circuit results in an avalanche effect as the voltages increase. That is, as more current flows through the delay start capacitor CST, the degree of asymmetry between the first and second lamp circuit paths increases so as to increase the voltages at the transformer windings until the second lamp strikes. After the second lamp strikes, the circuit asymmetry changes since current is now flowing through the second lamp. This asymmetry increases the voltage applied to the first lamp by the first primary winding WI until the first lamp strikes. As described above, once both lamps settle to operational levels, the resonant capacitor CR energizes the lamps since flux generated by the transformer windings is substantially canceled by other windings. Thus, after the lamps strike the voltages applied to the lamp cathodes by the transformer substantially decreases since flux from W2 and W4 mutually cancel each other.

This circuit combines rapid start and instant start scenarios. More particularly, the lamp cathodes are initially energized by voltage heating while the PTC remains in low impedance mode. When the PTC switches to high impedance mode, the cathode voltage and lamp current levels increase until the lamps strike. When the lamps strike, the voltage applied to the lamp cathodes is minimized.

FIG. 7A shows an exemplary detailed circuit implementation providing illustrative component values and characteristics. It is understood that the component values can be readily varied by one of ordinary skill in the art without departing from the present invention.

One skilled in the art will appreciate further features and advantages of the invention based on the above-described embodiments. Accordingly, the invention is not to be limited by exemplary embodiments shown and described herein. All publications and references cited herein are expressly incorporated herein by reference in their entirety.

What is claimed is:

1. A ballast circuit, comprising:
an inverter circuit receiving a DC voltage across a positive voltage rail and a negative voltage rail and providing an AC voltage for energizing a load,
a resonant inductive element coupled at a first end to said inverter circuit and at a second end to said load so as to provide a current path from the inverter to the load, and
a voltage clamping circuit connected across said positive and negative voltage rails and coupled to said inductive element so as to clamp a voltage at the second end of the inductive element to a pre-determined positive value during a first half cycle of the inverter AC voltage and to a predetermined negative value during a second half cycle of the inverter AC voltage.

2. The ballast circuit of claim 1, wherein said voltage clamping circuit comprises:
a first clamping diode coupled between the second end of the inductive element and said positive voltage rail, and
a second clamping diode coupled between the second end of the inductive element and said negative voltage rail,
wherein a cathode terminal of one of said diodes is connected to an anode terminal of the other diode.

3. A ballast circuit, comprising
an inverter circuit receiving DC voltage from a positive rail and a negative rail and providing an AC voltage for energizing a load,
first and second resonant inductive elements inductively coupled to one another at a coupling junction, and coupled to the inverter circuit so as to provide a path for current flow from the inverter to the load, and
a voltage clamping circuit connected across said positive and negative voltage rails, said voltage clamping circuit clamping a voltage at the coupling junction of said first and second inductors to a pre-determined positive value during a first half cycle of the inverter AC voltage and to a pre-determined negative value during a second half cycle of the inverter AC voltage.

4. A ballast circuit according to claim 3, wherein said voltage clamping circuit comprises
a first clamping diode couple between the coupling junction of said first and second inductors and said positive voltage rail, and
a second clamping diode coupled between the coupling junction of said first and second inductors and said negative voltage rail.

5. A ballast circuit according to claim 4, wherein said inverter circuit comprises first and second switching elements arranged in a half bridge configuration.

6. A ballast circuit according to claim 5, further comprising
a first control circuit coupled to the first switching element for controlling a conduction state of the first switching element, and
a second control circuit coupled to the second switching element for controlling a conduction state of the second switching element.

7. A ballast circuit according to claim 6, wherein said first control circuit includes a first inductive bias element inductively coupled to said first and second resonant elements.

8. A ballast circuit according to claim 6, wherein said second control circuit includes a second inductive bias element inductively coupled to said first and second resonant inductive elements.

9. A ballast circuit according to claim 3, further comprising a DC blocking capacitor coupled in series between said load and one of said first and second resonant inductive elements.

10. A ballast circuit according to claim 3, wherein said load is a fluorescent lamp.

11. A ballast circuit, comprising
an inverter circuit receiving DC voltage across a positive voltage rail and a negative voltage rail and providing an AC voltage,
a first resonant inductive element coupled in series to a second resonant inductive element at a coupling junction, said first and second resonant inductive elements being inductively coupled to one another and said first resonant inductive element being connected to said inverter at one end thereof,
a voltage clamping circuit connected across said positive and negative voltage rails and coupled to said first and second resonant inductive elements such that it clamps a voltage at said coupling junction to a pre-determined positive value during a first half cycle of the inverter AC voltage and to a pre-determined negative value during a second half cycle of the inverter AC voltage, and
a transformer having a primary winding coupled in series to said first and second resonant inductive elements and having a secondary winding coupled to a load
wherein said inverter circuit applies an AC voltage to said primary winding which induces an AC voltage in the secondary winding for energizing said load.

12. A ballast circuit for energizing a load, comprising:
an inverter circuit receiving a DC voltage across a positive voltage rail and a negative voltage rail and providing an AC voltage,
a resonant inductive element coupled to a first end of said inverter circuit,
a transformer having a first primary winding coupled in series between a second end of said resonant inductive element and one of said positive and negative voltage rails,
a positive temperature coefficient (PTC) element coupled in series to said primary winding, said PTC having a low resistance at start-up so as to clamp a voltage across said lamp to a selected value.

13. The ballast circuit of claim 12, further comprising a resonant capacitor coupled in parallel to said primary winding, wherein said PTC limits current flow to said resonant capacitor at start-up thereby clamping a voltage across said lamp at start-up to a pre-determined value.

14. The ballast circuit of claim 12, wherein said load includes a gas discharge lamp having first and second filaments and said selected value is below a strike voltage.

15. The ballast circuit of claim 14, wherein said transformer further includes a second primary winding coupled in series with said first primary winding a second secondary winding coupled across said first filament, said PTC element being effective to clamp a voltage across the lamp below a strike voltage during start-up to allow heating of said first filament before ignition of the lamp.

16. The ballast circuit of claim 15, wherein said transformer further includes a third secondary winding coupled in series to said first and second secondary windings and coupled across said second filament of the lamp so as to heat up said second filament during start-up.

17. The ballast circuit of claim 14, wherein the secondary winding of the transformer forms a circuit loop with said first and second filaments so as to provide a current heating of the filaments during start-up while said PTC clamps a voltage across the lamp to prevent the lamp from striking.

18. The ballast circuit of claim 17, further comprising a capacitor connected in series with said filaments and said secondary winding within said circuit loop.

19. A ballast circuit, comprising:
an inverter circuit receiving a DC voltage across a positive voltage rail and a negative voltage rail and producing an AC voltage,
a resonant inductive element coupled at a first end to said inverter circuit,
a transformer coupled to a second end of said resonant inductive element and having first, second, and third primary, and a secondary winding, said first and second primary windings being inductively coupled and said secondary winding being coupled across said lamp,
a positive temperature coefficient (PTC) element being coupled to said first and second primary windings so as to form a circuit loop with said first and second primary windings, and
a resonant capacitive element coupled electrically in parallel to said third primary winding,
wherein said PTC element limits current to said resonant capacitive element during start-up period such that a voltage applied to the lamp remains below a strike voltage.

20. The ballast circuit of claim 19, wherein said inductive coupling between said first and second primary windings is configured such that during normal operation of the lamp magnetic flux through said first primary winding substantially cancels a flux through said second primary winding to substantially eliminate current through said PTC element during the normal operation.

21. The ballast circuit of claim 20, wherein said first primary winding is connected at one end to the second end of said resonant inductive element at a first circuit junction.

22. The ballast circuit of claim 21, further comprising:
a first diode connected at its anode terminal to said first circuit junction and at its cathode terminal to one of said voltage rails, and
a second diode connected at its cathode terminal to said first circuit junction and at its anode terminal to another one of said voltage rails,
wherein said diodes clamp a voltage at said first circuit junction to a selected value.

23. The ballast circuit of claim 19, wherein said inverter circuit includes first and second switching element coupled to one another in a half bridge configuration.

24. A ballast circuit for energizing a fluorescent lamp, comprising:
an inverter circuit receiving a DC voltage across a positive voltage rail and a negative voltage rail and producing an AC voltage,
first and second inductive elements coupled in series to one another at a first circuit junction, said first inductive element being coupled at one end to said inverter circuit,
first and second diodes coupled end-to-end between said first and second voltage rails such that an anode terminal of said first diode is connected to a cathode terminal of said second diode at a second circuit junction,
a positive temperature element (PTC) coupled between said first circuit junction and said second circuit junction,
a transformer coupled to said inductive elements and to said lamp so as to energize the lamp, said transformer having first, second and third windings, said first winding being coupled at one end to said second inductive element and at another end to one end of said second winding, said second winding being coupled across a cathode of the lamp and said third winding being coupled across an anode of the lamp, and
a resonant capacitive element coupled between the second end of said second inductive element and one of said voltage rails,
wherein said PTC element limits current flow through said resonant capacitor and hence limits a voltage applied to said lamp during start-up period so as to allow heating of the cathode while preventing the lamp from striking.

25. The ballast circuit of claim 24, further comprising a DC blocking capacitor coupled electrically in series between said second inductive element and said first winding of the transformer.

26. The ballast circuit of claim 24, wherein said transformer includes fourth and fifth windings coupled in series to one another, said fourth winding being coupled at one end to the second end of said second inductive element and said fifth winding being coupled across a cathode terminal of a second lamp, said lamp having an anode terminal coupled across said third winding of the transformer.

27. The ballast circuit of claim 26, wherein said fifth winding is inductively coupled to said second winding such that a flux in one of said second and fifth windings substantially cancels a flux in the other winding during a normal operation of the lamp.

28. A ballast circuit for energizing a fluorescent lamp, comprising:
an inverter circuit receiving a DC voltage across a positive voltage rail and a negative voltage rail and producing an AC voltage,
first and second inductive elements coupled in series to one another at a first circuit junction, said first inductive element being coupled at one end to said inverter circuit,
first and second diodes coupled end-to-end between said first and second voltage rails such that an anode terminal of said first diode is connected to a cathode terminal of said second diode at a second circuit junction,
a positive temperature coefficient (PTC) element couple between said first circuit junction and one said voltage rails,
a transformer coupled to said inductive elements and to said lamp so as to energize the lamp, said transformer having first, second and third windings, said first winding being coupled at one end to said second inductive element and at another end to one end of said second winding, said second winding being coupled across a cathode of the lamp and said third winding being coupled across an anode of the lamp, and
a resonant capacitive element coupled between the second end of said second inductive element and one of said voltage rails,
wherein said PTC element limits current flow through said resonant capacitive element and hence limits a voltage applied to said lamp during start-up period so as to allow heating of the cathode while preventing the lamp from striking.
